(19) United States
(12) Patent Application Publication
(10) Pub. No.: US 2007/0139340 A1
(43) Pub. Date: Jun. 21, 2007

(54) Flat panel display

(75) Inventors: Wen-Tsung Lin, Tainan (TW); Yung-Li Huang, Tainan (TW); Ying-Wen Yang, Tainan (TW)

Correspondence Address: FISH & RICHARDSON PC, P.O. BOX 1022, MINNEAPOLIS, MN, 55440-1022, US

(73) Assignee: Chi Mei Optoelectronics Corporation, Tainan (TW)

(21) Appl. No.: 11/582,810

(22) Filed: Oct. 18, 2006

(30) Foreign Application Priority Data
Dec. 16, 2005 (TW) 94144865

(51) Int. Cl. G09G 3/36

(52) U.S. Cl. 345/98

(57) ABSTRACT

A flat panel display includes pixel circuits, a signal divider for associating portions of the image signal with corresponding portions of the pixel circuits, and timing controller circuitry for receiving the portions of the image signal and outputting corresponding sets of control signals and pixel data, the timing controller circuitry outputting the sets in parallel. The flat panel display includes groups of data drivers, each group for receiving respective sets of control signals and pixel data from the timing controller circuitry and driving corresponding pixel circuits, different groups receiving the sets in parallel.

### CROSS REFERENCE TO RELATED APPLICATIONS

This application claims priority to Taiwan application serial no. 94144865, filed Dec. 16, 2005, the contents of which are incorporated by reference.

### BACKGROUND OF THE INVENTION

The description relates to flat panel displays.

Referring to FIG. 1, an example of a flat panel display is an active matrix thin film transistor (TFT) liquid crystal display 100 that includes a flat panel 102, a timing controller 104, data drivers 106, a scan driver 108, and a scaler 110. The flat panel 102 has an array of pixel circuits. Each pixel circuit includes a TFT, a storage capacitor, and a liquid crystal cell. The scan driver 108 controls when the TFTs are turned on to allow corresponding data drivers to drive the storage capacitors. The data drivers 106 convert digital pixel data from the timing controller 104 into analog voltage signals that drive the storage capacitors. The voltage levels across the storage capacitors are applied to the liquid crystal cells to control the amount of light that passes through the cells, thereby determining the gray scales shown by the pixel circuits. The timing controller 104 receives an input image signal from the scaler 110, which in turn receives an input image signal from a host computer 112. The timing controller 104 controls the scan driver 108 and data drivers 106 to drive the pixel circuits according to the input image signal to show images on the flat panel 102.

### SUMMARY

In one aspect, in general, a flat panel display includes a panel having pixel circuits, a signal divider for associating portions of the image signal with corresponding portions of the pixel circuits, timing controller circuitry for receiving the portions of the image signal and outputting corresponding sets of control signals and pixel data, the timing controller circuitry outputting the sets in parallel. The flat panel display includes groups of data drivers, each group for receiving respective sets of control signals and pixel data from the timing controller circuitry and driving corresponding pixel circuits, different groups receiving the sets in parallel.

Implementations of the method may include one or more of the following features. Each group includes at least one pair of data drivers, each pair of data drivers including a first data driver located at a first side of the panel and a second data driver located at a second side of the panel. At least a portion of the timing controller circuitry is located between the first side of the panel and the second side of the panel. The distances from the timing controller circuitry to a corresponding pair of data drivers are substantially the same. The timing controller circuitry includes at least two timing controllers. The signal divider includes a demultiplexer to send the portions of the image signal to corresponding timing controllers. The signal divider includes a buffer to store the portions of the image signal, the signal divider sending the different portions stored in the buffer to the corresponding timing controllers in parallel. Different timing controllers correspond to different numbers of pixel circuits. The signal divider divides the input image signal into portions based on the configurations of the timing controllers. Each timing controller adjusts gray scale levels of pixel data to overdrive the pixel circuits. The signal divider includes a counter that generates a count value for use in dividing the input image signal into portions. The signal divider includes at least one of a field-programmable gate array and an application specific integrated chip. The panel includes a liquid crystal panel.

In another aspect, in general, an apparatus includes at least two timing controllers to control groups of data drivers that drive pixel circuits of a flat panel display, different timing controllers sending pixel data to different groups in parallel, and a signal divider to divide an input image signal into portions and send the portions to corresponding timing controllers.

Implementations of the method may include one or more of the following features. The data drivers convert digital pixel data from the timing controllers into analog voltage signals. The timing controllers adjust gray scale levels of pixel data to overdrive the pixel circuits.

In another aspect, in general, a method of driving a flat panel display that includes a panel having pixel circuits, timing controller circuitry, and groups of data drivers, the method includes associating portions of an image signal with corresponding portions of the pixel circuits, sending the portions of the image signal to the timing controller circuitry, generating, using the timing controller circuitry, sets of control signals and pixel data based on the portions of the image signal, sending the sets of control signals and pixel data from the timing controller circuitry to corresponding groups of data drivers in parallel, and driving the pixel circuits using the data drivers to show an image on the panel.

Implementations of the method may include one or more of the following features. Dividing the input image signal includes dividing the input image signal based on a count value generated by a counter. The timing controller circuitry includes at least two timing controllers. The method includes dividing the input image signal into unequal portions, at least one of the portions corresponding to more pixel circuits than another one of the portions. The method includes dividing the input image signal into substantially equal portions, each portion corresponding to substantially the same number of pixel circuits as the other portions. Each group includes at least one pair of data drivers, each pair of data driver includes a first data driver located at a first side of the panel and a second data driver located at a second side of the panel. The method includes sending the same pixel data to the first and second data driver of a pair, and using the first and second data driver to drive the same pixel circuits.

In another aspect, in general, a method includes sending digital pixel data from at least two timing controllers to corresponding data drivers in parallel, converting, using the data drivers, the digital pixel data to analog voltage signals, and driving, using the data drivers, pixel circuits of a flat panel display in parallel using the analog voltage signals.

Implementations of the method may include one or more of the following features. The method includes receiving an input image signal according to a first clock signal, dividing the input image signal into at least two portions, and sending the portions to corresponding timing controllers. Sending the digital pixel data from the timing controllers to the data drivers includes sending the digital pixel data according to a second clock signal having a frequency lower than the first clock signal.

Advantages of the flat panel display include one or more of the following. By using multiple timing controllers, the signal frequency used for sending pixel data to the data drivers can be reduced. Electromagnetic interference caused by high frequency signals can be reduced. Existing timing controllers for smaller-size flat panel displays can be used for larger-size flat panel displays. By using pairs of data drivers on both sides of a display panel, the driving signal strength can be substantially the same for pixels located at different regions of the display. The distance between pixel circuits and data drivers can be reduced so that the display can have a faster response time.

### DESCRIPTION OF DRAWINGS

FIGS. 1 to 3 are diagrams of flat panel displays.

### DETAILED DESCRIPTION

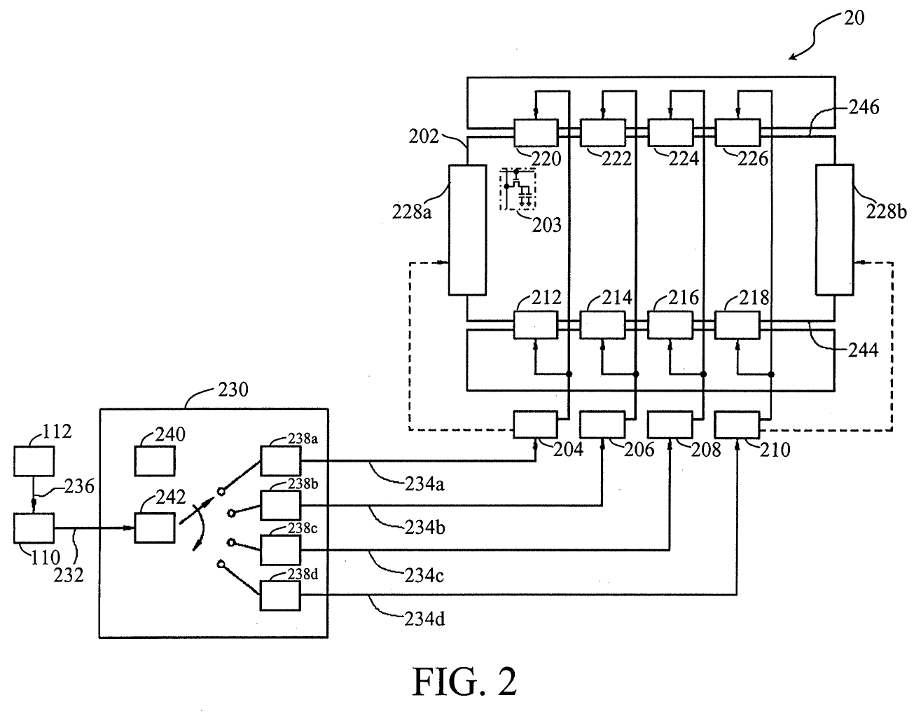

FIG. 2 is a diagram of an example of a flat panel display 20 that includes a panel 202 having an array of pixel circuits 203 (only one is shown), four timing controllers (204, 206, 208, and 210), four pairs of data drivers ((212, 220), (214, 222), (216, 224), and (218, 226)), two scan drivers (228a and 228b), and a signal divider 230. Each pair of data drivers has a first data driver (e.g., 212) positioned on a first side 244 of the panel 202 and a second data driver (e.g., 220) positioned on a second side 246 of the panel 202. The flat panel display 20 can have a large size and a high resolution. For example, the panel 202 can be a quad full high definition display panel having a diagonal viewing size of 56 inches and a resolution of 3840×2160 pixels.

The data drivers (212 to 226) and scan drivers (228a, 228b) may be positioned at peripheral areas of the panel 202 so that they do not block the pixel circuits. The timing controllers (204 to 210) may be positioned at the back of the panel 202 and connect to the data drivers through flexible printed circuits.

A host computer 112 sends an image signal 236 for an image frame to a scaler 110, which scales the image signal 236 and outputs an image signal 232 to the signal divider 230. The signal divider 230 divides the image signal 232 into four portions 234a, 234b, 234c, 234d and sends the four portions to the timing controllers 204, 206, 208 and 210, respectively. Each of the portions is associated with a corresponding portion of the pixel circuits. In some examples, the divider 230 has buffers 238a to 238d for storing the four portions 234a to 234d. When the buffers 238a to 238d are fully loaded with the four portions, the buffers send the four portions to the four timing controllers (204 to 210) in parallel. Then the divider 230 receives an image signal 236 for the next image frame, divides the pixel data for the image frame into four portions, and sends the four portions to the four timing controllers, and so forth.

The signal divider 230 may include a counter 240 and a selector 242 (or demultiplexer). In some examples, the scaler 110 sends pixel data for each column sequentially, e.g., from column 0 to column 3839 of one frame, then from column 0 to column 3839 of a next frame, and so forth. The counter 240 generates a count value indicating the column of data that are being received. The selector 242 selects the buffers 238a to 238d according to the count value.

For example, the timing controllers 204 to 210 may receive equal portions of pixel data. For a display having 3840 horizontal resolution, each timing controller receives pixel data for 960 columns. When the counter 240 outputs count values 0 to 959, indicating that pixel data for columns 0 to 959 are being received, the selector 242 sends the pixel data to the first buffer 238a. When the counter 240 outputs count values 960 to 1919, indicating that pixel data for columns 960 to 1919 are being received, the selector 242 sends the pixel data to the second buffer 238b, and so forth. After the pixel data for columns 0 to 3839 are stored in the buffers 238a to 238d, the buffers 238a to 238d output the pixel data in parallel to the timing controllers 204 to 210, respectively.

The signal divider 230 may be implemented using, e.g., a field-programmable gate array (FPGA) or an application specific integrated chip (ASIC).

The timing controllers 204, 206, 208, 210 process the portions 234a, 234b, 234c, 234d, respectively, and generate control signals and pixel data. For example, the timing controllers may adjust the gray scales of the image signals to perform overdriving of the pixel circuits. The timing controllers may also adjust the white balance according to a user-selected color temperature. Each of the timing controllers 204, 206, 208, 210 sends its pixel data to its pair of data drivers in parallel. The timing controllers 204, 206, 208, 210 also send data in parallel. Because pixel data are sent to the pairs of data drivers in parallel, the signal frequency for transmitting pixel data to each pair of data drivers can be reduced, as compared to using a single timing controller to send pixel data to the pairs of data drivers in sequence.

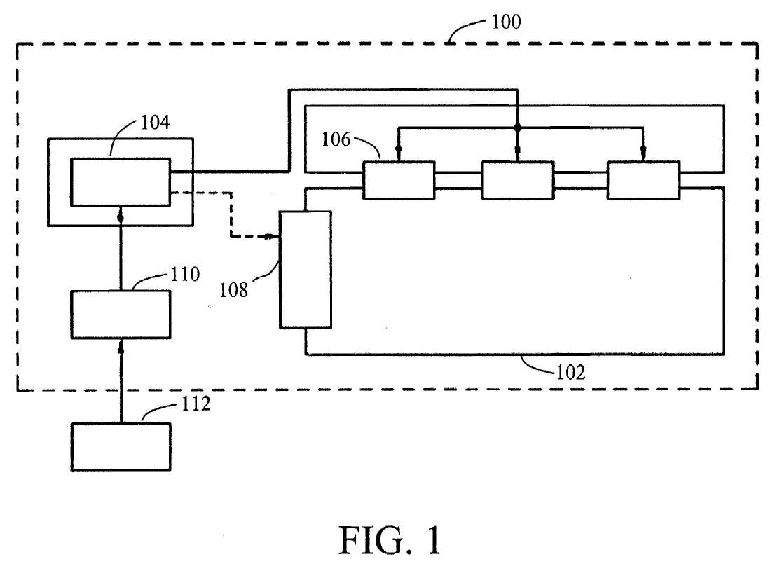

For example, for a display having a resolution of 3840×2160 pixels, the rate at which pixel data needs to be transmitted from the timing controller(s) to the data drivers is about 3840×2160×3×60×8=1.19×10¹⁰ bits per second. This assumes that the frame rate is 60 Hz, each pixel includes three primary colors, and each color is being represented by 8 bits. If only one timing controller were used (e.g., as in FIG. 1), and were to send data to each of the four pairs of data drivers in sequence, the timing controller would have to send 3840/4×2160×3×8=49.8 gigabits of pixel data to the first pair of data drivers 212 and 220 during a 1/240 second period, so the bit rate of signals from the timing controller to the data drivers would be at least about 11.9 gigabits per second during the 1/240 second period. By comparison, when four timing controllers are used, each timing controller sends about 49.8 gigabits of pixel data to the data drivers during a 1/60 second period, so the bit rate of signals from each of the timing controllers to the data drivers can be reduced to about 2.99 gigabits per second. Reducing the bit rate results in lower transmission signal frequency and less electromagnetic interference, resulting in better image quality.

The timing controllers 204 and 210 transmit control signals to the scan drivers 228a and 228b, respectively, to cause the scan drivers 228a and 228b to successively turn on the TFTs of each row of pixel circuits to enable data drivers to drive the storage capacitors of the rows of pixel circuits.

When the size of the panel 202 is large, there may be parasitic capacitances associated with the data lines. When a data driver positioned at the first side 244 drives pixels near the second side 246 of the panel 202 through the data lines, the driving signal may weaken because of the signal has to travel a long distance. Weaker signals may result in lower voltage levels, causing inaccurate display of gray scales and colors. Also, the longer the distance between the data driver and the pixel circuit, the longer the time required for the driving signal to reach the pixel circuit, which results in poor image uniformity.

For this reason, two data drivers are positioned at the first side 244 and the second side 246, respectively, of the panel 202 to drive the pixel circuits at the same time. In this example, the data drivers of each pair are electrically connected, receive the same pixel data, and drive the same pixel circuits. For example, the data drivers 220 and 212 receive the same pixel data from the timing controller 204 and drive the same pixel circuits.

By using a pair of data drivers 212 and 220 located on two sides of the panel 202 to drive corresponding pixel circuits simultaneously, the strengths of driving signals reaching the pixels can be increased. The strengths of driving signals can be more uniform for all pixel circuits associated with the data drivers 212 and 220, regardless of the distances between the pixel circuits and the data drivers. This results in more accurate display of gray scales and colors. The maximum distance from a pixel circuit to a data driver is reduced by about half (as compared to using data drivers positioned on only one side of the panel 202), so the time required for the driving signals to reach the pixels can be reduced by about half, resulting in faster response of the pixel circuits.

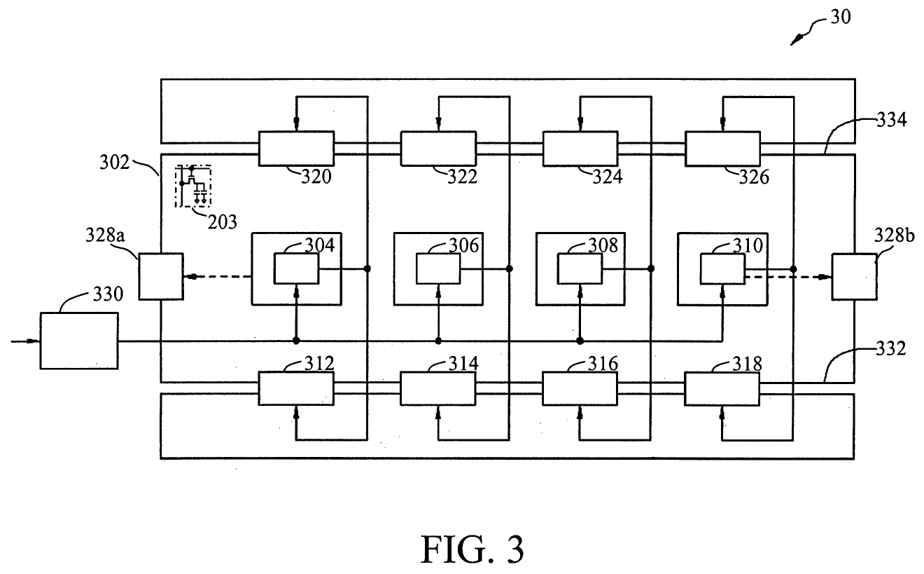

FIG. 3 is a diagram of a flat panel display 30 that includes a panel 302 having an array of pixel circuits 203 (only one is shown), four timing controllers (304, 306, 308, and 310), four pairs of data drivers ((312, 320), (314, 322), (316, 324), and (318, 326)), two scan drivers (328a and 328b), and a signal divider 330. For example, the panel 302 can have a diagonal viewing size of 56 inches and a resolution of 3840×2160 pixels.

The data drivers 320, 322, 324, and 326 that are located at a first side 332 of the panel 302 will be referred to as the first data drivers. The data drivers 312, 314, 316, and 318 that are located at a second side 334 of the panel 302 will be referred to as the second data drivers.

A difference between the displays 30 and 20 (FIG. 2) is that the timing controllers (304, 306, 308, 320) in FIG. 3 are located about half way between the first side 332 and the second side 334 (although other positions different from half way would be useful, too), so that the distances between the timing controllers (304, 306, 308, 320) to corresponding first data drivers (312, 314, 316, 318) and to corresponding second data drivers (320, 322, 324, 326), respectively, are substantially the same. The pixel data sent from the timing controllers will reach the first and second data drivers at about the same time.

In display 30, the maximum distance from the timing controllers (304, 306, 308, 320) to the data drivers is reduced by about half, as compared to the display 20 (FIG. 2), so the time required for pixel data to travel from the timing controllers to the data drivers can be reduced by about half.

Although some examples have been discussed above, other implementations and applications are also within the scope of the following claims. For example, the divider 230 can send the portions 234a to 234d to the timing controllers 204 to 210 sequentially instead of in parallel. The displays can have different numbers of timing controllers, data drivers, and scan drivers. In displays 20 and 30, each timing controller may correspond to multiple pairs of data drivers, each pair of data drivers including a first data driver located at a first side of the panel and a second data driver located at a second side of the panel.

The timing controllers can be associated with different number of columns of pixels. For example, suppose a first type of timing controller can drive displays having 1024 columns, and a second type of timing controller can drive displays having 800 columns. One of the first type of timing controller and two of the second type of timing controllers can be used to drive a display having 1024+800×2=2624 columns (or less). The divider 230 can have three buffers, one buffer for each of the three timing controllers. In the example of a display having 2624 horizontal resolution, when the count value provided by the counter 240 is between 0 to 1023, the image signal is sent to the first timing controller. When the count value provided by the counter 240 is between 1024 to 1823, the image signal is sent to the second timing controller. When the count value provided by the counter 240 is between 1823 to 2623, the image signal is sent to the third timing controller, and so forth.

What is claimed is:

1. A flat panel display, comprising:
pixel circuits;
a signal divider for associating portions of the image signal with corresponding portions of the pixel circuits;
timing controller circuitry for receiving the portions of the image signal and outputting corresponding sets of control signals and pixel data, the timing controller circuitry outputting the sets in parallel; and
groups of data drivers, each group for receiving respective sets of control signals and pixel data from the timing controller circuitry and driving corresponding pixel circuits, different groups receiving the sets in parallel.

2. The flat panel display of claim 1 wherein each group includes at least one pair of data drivers, each pair of data drivers including a first data driver located at a first side of the panel and a second data driver located at a second side of the panel.

3. The flat panel display of claim 2 wherein at least a portion of the timing controller circuitry is located between the first side of the panel and the second side of the panel.

4. The flat panel display of claim 3 wherein the distances from the timing controller circuitry to a corresponding pair of data drivers are substantially the same.

5. The flat panel display of claim 1 wherein the timing controller circuitry comprises at least two timing controllers.

6. The flat panel display of claim 5 wherein the signal divider comprises a demultiplexer to send the portions of the image signal to corresponding timing controllers.

7. The flat panel display of claim 5 wherein the signal divider comprises a buffer to store the portions of the image signal, the signal divider sending the different portions stored in the buffer to the corresponding timing controllers in parallel.

8. The flat panel display of claim 5 wherein different timing controllers correspond to different numbers of pixel circuits.

9. The flat panel display of claim 8 wherein the signal divider divides the input image signal into portions based on the configurations of the timing controllers.

10. The flat panel display of claim 1 wherein each timing controller adjusts gray scale levels of pixel data to overdrive the pixel circuits.

11. The flat panel display of claim 1 wherein the signal divider comprises a counter that generates a count value for use in dividing the input image signal into portions.

12. The flat panel display of claim 1 wherein the signal divider comprises at least one of a field-programmable gate array and an application specific integrated chip.

13. The flat panel display of claim 1 wherein the panel comprises a liquid crystal panel.

14. An apparatus, comprising:
at least two timing controllers to control groups of data drivers that drive pixel circuits of a flat panel display, different timing controllers sending pixel data to different groups in parallel; and
a signal divider to divide an input image signal into portions and send the portions to corresponding timing controllers.

15. The apparatus of claim 14 wherein the data drivers convert digital pixel data from the timing controllers into analog voltage signals.

16. The apparatus of claim 14 wherein the timing controllers adjust gray scale levels of pixel data to overdrive the pixel circuits.

17. A method of driving a flat panel display that comprises a panel having pixel circuits, timing controller circuitry, and groups of data drivers, the method comprising:
associating portions of an image signal with corresponding portions of the pixel circuits;
sending the portions of the image signal to the timing controller circuitry;
generating, using the timing controller circuitry, sets of control signals and pixel data based on the portions of the image signal;
sending the sets of control signals and pixel data from the timing controller circuitry to corresponding groups of data drivers in parallel; and
driving the pixel circuits using the data drivers to show an image on the panel.

18. The method of claim 17 wherein dividing the input image signal comprises dividing the input image signal based on a count value generated by a counter.

19. The method of claim 17 wherein the timing controller circuitry comprises at least two timing controllers.

20. The method of claim 17, further comprising dividing the input image signal into unequal portions, at least one of the portions corresponding to more pixel circuits than another one of the portions.

21. The method of claim 17, further comprising dividing the input image signal into substantially equal portions, each portion corresponding to substantially the same number of pixel circuits as the other portions.

22. The method of claim 17 wherein each group comprises at least one pair of data drivers, each pair of data driver comprising a first data driver located at a first side of the panel and a second data driver located at a second side of the panel.

23. The method of claim 22, further comprising sending the same pixel data to the first and second data driver of a pair, and using the first and second data driver to drive the same pixel circuits.

24. A method comprising:
sending digital pixel data from at least two timing controllers to corresponding data drivers in parallel;
converting, using the data drivers, the digital pixel data to analog voltage signals; and
driving, using the data drivers, pixel circuits of a flat panel display in parallel using the analog voltage signals.

25. The method of claim 24, further comprising receiving an input image signal according to a first clock signal, dividing the input image signal into at least two portions, and sending the portions to corresponding timing controllers.

26. The method of claim 25 wherein sending the digital pixel data from the timing controllers to the data drivers comprises sending the digital pixel data according to a second clock signal having a frequency lower than the first clock signal.
